(19) United States
(12) Patent Application Publication
(10) Pub. No.: US 2023/0087647 A1
(43) Pub. Date: Mar. 23, 2023

(54) Systems and Methods for Conduit Deburr

(71) Applicant: Charles A. Statton, Orfordville, WI (US)

(72) Inventor: Charles A. Statton, Orfordville, WI (US)

(21) Appl. No.: 17/944,426

(22) Filed: Sep. 14, 2022

Related U.S. Application Data
(60) Provisional application No. 63/245,539, filed on Sep. 17, 2021.

(51) Int. Cl. B23B 5/16

(52) U.S. Cl. CPC B23B 5/167

(57) ABSTRACT

Systems and methods for conduit deburring include rotational bits and/or supporting structure for reducing burrs on conduit or other pipe or tubing, which often result from cutting. Certain devices simultaneously act on an entire circumference of a tubular end opening. Other devices act on only a portion of a circumference of a tubular end opening, but are guided, registered, or oriented for travel along the circumference to cut a chamfer of a predetermined angle along an interior edge thereof.

### RELATED APPLICATIONS

This application claims priority to and the benefit of co-pending U.S. provisional patent application No. 63/245,539, filed 17 Sep. 2021, and entitled “Systems and Methods for Conduit Deburr,” which is incorporated by reference herein in its entirety.

### BACKGROUND OF THE INVENTION

In the field of electrical wiring installation, conduit serves an important function of protecting electrical wiring from the environment, as well as protecting the environment from the electrical wiring. Conduit is often made of hard, dense material, so as to provide the best protection for the wiring. This material is typically metal or polyvinyl chloride (PVC). However, no matter what material is chosen for conduit, the installer may have to deal with conduit burrs.

Conduit burrs generally form jagged edges that remain after cutting conduit. When installing the conduit, it is often necessary to cut the material into shorter pieces. The cutting process can be achieved with sophisticated cutting tools known in the art or even by a simple hacksaw. However, the usual result is that the cut conduit will be left with rough, often uneven edges including small bits of jagged material, known as burrs. Burrs can be a major problem in electrical wiring installation, as they can cause even worse wear and damage to the wires than the environment that the conduit was meant to protect the wires from. For instance, if burrs are not removed and the conduit is installed, when wires are pulled therethrough, the burrs may damage electrical insulation provided on the wires. Burrs can further cause injury to a conduit installer. Therefore, it is desirable to rid the conduit of these burrs, preferably before wire installation.

Over time, many methods have been employed to deburr conduit. For instance, workers have used a utility knife or other blade to smooth out conduit edges in a method known as manual deburring. Manual deburring involves scratching an edge of an implement along a cut conduit edge to scrape the burrs off. Some rely on electrochemical reactions to dissolve burrs in hard to reach places. Still others prefer thermal deburring, where an explosive gas mixture is used to literally burn off burrs quickly and efficiently. However, these methods can have significant drawbacks. Manual deburring can be time consuming if workers have to manually smooth out every conduit edge. It can also be dangerous, as there is always a risk of the knife slipping and injuring a worker's hand. Electrochemical and thermal deburring are quicker, but can also be dangerous if the mixtures happen to make contact with an unprotected worker.

One of the most popular methods for deburring conduit is mechanical deburring, where the worker uses a deburring tool to grind down edges of the conduit. These tools typically involve inserting a drill bit into a conduit end and grinding the edge until the burrs are removed. This process is quick, efficient, and relatively danger free compared to other deburring processes. However, even this process has drawbacks. For instance, some tools could produce uneven conduit edges or create burrs of their own if they have been dulled by use or are not installed in the drill properly. Other tools may not be able to deburr certain sizes of conduit. For conduit that has a thickness greater than 1 inch, workers may have trouble keeping the deburring tool against the conduit edge, thus losing the smooth edge they desire. Therefore, a quick, efficient, safe conduit deburring system that can reliably deburr conduit of any common size is desired.

### SUMMARY OF THE INVENTION

Embodiments of apparatus and methods according to the present invention relate generally to systems and methods for deburring a conduit or other pipe or tube. More specifically, the present invention relates to systems and methods for reducing burrs and at least substantially automatically guiding a deburring bit, or portion thereof, into or along an edge of a conduit.

An embodiment of a system for deburring conduit according to the present invention has a shank extending from a proximal free end to a distal end, an end stop plate configured as a disk having a proximal side and an opposing distal side, the proximal side of the end stop plate being coupled to the distal end of the shank, and a plurality of cutting flutes extending from the distal side of the end stop plate. Each cutting flute converges completely towards all other flutes and the flutes terminate at a pointed free end spaced from the distal side of the end stop plate.

According to an aspect of a system for deburring conduit according to the present invention, the shank has a circular cross-section.

According to another aspect of a system for deburring conduit according to the present invention, the shank has a hexagonal cross-section.

According to still another aspect of a system for deburring conduit according to the present invention, the end stop plate is formed integrally with the shank.

According to yet another aspect of a system for deburring conduit according to the present invention, each cutting flute comprises two converging substantially right triangle side surfaces and an isosceles triangular radial surface.

According to a further aspect of a system for deburring conduit according to the present invention, the plurality of cutting flutes are bi-directionally operable.

According to another embodiment of a system for deburring conduit according to the present invention, it includes a drill guard, having a conduit face, a drill face, and a shank aperture, a locking collar mechanically connected to the drill face of the drill guard, the locking collar being co-axial with the shank aperture, a pipe guide mechanically connected to the drill guard, a fitting pipe affixed to and extending longitudinally from the conduit face of the drill guard, and a rotary file having a shank, extending from a proximal free end to a distal end, and a rotary head affixed to the distal end of the shank. The rotary file is removably rotatably supported through the drill guard by threading the proximal free end of the hex shank through the shank aperture and locking the locking collar.

According to an aspect of a system for deburring conduit according to the present invention, the rotary head is frustoconical.

According to another aspect of a system for deburring conduit according to the present invention, the conduit face has a reinforcing layer.

According to still another aspect of a system for deburring conduit according to the present invention, the pipe guide includes a stud threaded through the drill guard, so that the pipe guide extends from the conduit face of the drill guard.

According to yet another aspect of a system for deburring conduit according to the present invention, the locking collar includes a set screw.

According to an embodiment of a method for deburring conduit according to the present invention, the method includes the steps of providing a conduit having an end to be deburred, the conduit having a cross-sectional diameter, determining the size of the diameter, selecting a conduit deburr system based on the determined size, contacting the conduit deburr system with the conduit, and deburring the conduit.

According to an aspect of a method for deburring conduit according to the present invention, the determining step includes ascertaining if the diameter is less than or greater than 1.25 inches in size.

According to another aspect of a method for deburring conduit according to the present invention, the diameter is determined to be less than 1.25 inches and the selected conduit deburr system is the deburr system according to claim 1.

According to still another aspect of a method for deburring conduit according to the present invention, the installing step includes the steps of chucking the shank to a drill and aligning the shank substantially coaxially with an opening in the end. The pointed ends of the cutting flutes extend into the conduit.

According to yet another aspect of a method for deburring conduit according to the present invention, the deburring step includes the steps of activating the drill to rotate the shank, drilling until the end stop plate makes contact with the conduit end, deactivating the drill, removing the cutting flutes from the conduit opening, and removing the shank from the drill.

According to a further aspect of a method for deburring conduit according to the present invention, the conduit is determined to be greater than 1.25 inches and the selected conduit deburr system is the deburr system of claim 7.

According to a still further aspect of a method for deburring conduit according to the present invention, the installing step further includes the steps of chucking the hex shank to a drill and fitting the conduit over the fitting pipe until the rotary head contacts the conduit edge and/or inside wall.

According to a still further aspect of a method for deburring conduit according to the present invention, the deburring step further includes the steps of activating the drill slowly to register the conduit between the pipe guide and fitting guide, drilling until the rotary head shaves off the burrs of the conduit wall and leaves a smooth finish, deactivating the drill, removing the conduit from the fitting pipe and removing the shank from the drill.

According to a still further aspect of a method for deburring conduit according to the present invention, the providing step includes the step of cutting the conduit to a predetermined length.

### BRIEF DESCRIPTION OF THE DRAWINGS

FIG. 1A is a perspective view of a first embodiment of a deburring device according to the present invention. FIG. 1B is a right side elevation thereof.

FIG. 2 is a right elevation view of a second embodiment of a conduit deburring device according to the present invention.

FIG. 3 is a front elevation view of the embodiment of FIG. 2.

FIG. 4 is a rear elevation view of the deburr device of FIG. 2.

FIG. 5 is a partial cross-sectional elevation view of a conduit end subjected to methods according to the present invention.

### DESCRIPTION OF THE PREFERRED EMBODIMENT

Although the disclosure hereof is detailed and exact to enable those skilled in the art to practice the invention, the physical embodiments herein disclosed merely exemplify the invention which may be embodied in other specific structures. While the preferred embodiment has been described, the details may be changed without departing from the invention.

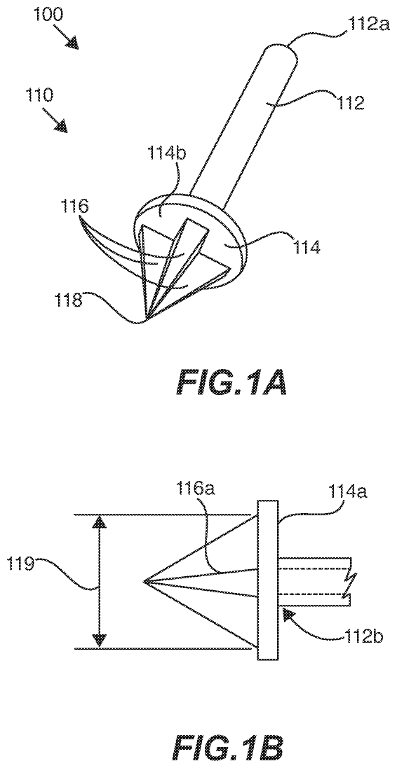

Turning now to the Figures, exemplary embodiments of systems and methods for conduit deburr according to the present invention can be seen. A first embodiment of a conduit deburr system 100, seen in FIG. 1 below, includes a drill bit 110 sized according to the conduit size sought to be deburred. The drill bit 110 preferably comprises a shank 112 (e.g., with hexagonal or circular cross-section), an end stop plate 114 and a plurality of cutting flutes 116. Each part 112-116 of the drill bit 110 is preferably made of metal, such as various grades of carbon (low or high) steel (which may be coated with or include cobalt, tungsten, molybdenum) for durability in both use and storage. During manufacturing, the parts 112-116 may be formed simultaneously or otherwise as a single piece of cast and/or machined metal. Alternatively, each part may be separately created and secured together using common techniques (e.g., welding) known in the art.

The shank 112 is preferably a hex shank to allow the drill bit 110 to pair with a chuck in any common model of drill or electric screwdriver. The shank 112 generally extends from a proximal free end 112a to a distal end 112b, the distal end 112b being coupled to or formed integrally with the end stop plate 114. The end stop plate 114 is preferably formed as a disk having a proximal side 114a coupled to or formed integrally with the distal end 112b of the shank 112, and an opposing distal side 114b. Protruding outward from the distal side 114b of the plate 114 are the plurality of cutting flutes 116. The cutting flutes 116 preferably converge towards a distal end 118, and each flute 116 may converge completely towards all other flutes 116, terminating in an acute generally pyramidal pointed end 118. While the flutes 116 shown generally have two converging right triangle side surfaces and an isosceles triangular radial surface, other fluting shapes are contemplated. In other embodiments not shown in the Figures, the bit 110 may feature more or fewer cutting flutes 116 with varying shapes and patterns.

The flutes 116 are all preferably formed substantially identically to each other. The flutes 116 may be provided as bi-directionally operable, substantially as shown, or a leading edge 116a of one or more of the flutes 116 may be hollow ground or cast, or sharpened, to allow for a directional (e.g., clockwise or counterclockwise) cut. The flutes 116 preferably extend proximally from the distal end 118 back to the distal side 114b of the plate 114. Measured at the distal side 114b of the plate 114, the flutes 116 span a maximum flute diameter 119, the plate 114 having a diameter (which may be at least substantially similar to an outer diameter CD (see FIG. 5) of a conduit to be deburred) that is preferably greater than the maximum flute diameter 120. The maximum flute diameter 119 is preferably a predetermined measurement that may relate to the outer diameter CD of a conduit to be deburred. The maximum flute diameter 119 may be a function (e.g. related to a percentage) of the thickness of the conduit tube wall 302 to be deburred (e.g., (CD-CI)/4 would leave an end wall thickness T of about the thickness of the wall 302), or simply a difference between the outer diameter CD and twice an end wall thickness T to remain after deburr (e.g. CD-2T). An advantage of using the latter method of relating maximum flute diameter 119 to conduit size is that, at least for PVC conduit, the schedule (or tube wall thickness (CD-CI)/2) can largely be ignored. That is, for a 1″ nominal PVC tube, both schedule 40 and schedule 80 pipe have an outer diameter CD of 1.315″. However, schedule 40 has an internal diameter CI of 1.004″ and schedule 80 has an internal diameter CI of 0.910″. However, if a predetermined end wall thickness T is known (e.g., 0.05″ to about 0.075″, with about 0.0625″ being preferred), then a simple calculation of a preferred maximum flute diameter 119 may be 1.315″−(0.0625*2)=1.190″.

With continuing reference also to FIG. 5, to perform the deburring process using the first embodiment 100, the shank 112 is chucked within a drill or electric screwdriver, and, preferably thereafter, the convergent tip 118 is inserted into an open end 304 of a tube 300 (e.g., conduit). The drill is then powered on, causing the drill bit 110, and simultaneously the cutting flutes 116, to rotate. As the flutes 116 rotate, they shave off portions of the edge and inner wall of the conduit 300, reducing (or preferably completely removing) burrs and leaving a smooth finish in the form of a circumferential chamfer 306 provided at a predetermined angle 308 (preferably about 25 degrees to about 45 degrees, with about 30 degrees being preferred) with respect to the longitudinal direction of the conduit 300. As pressure is applied to the drill bit 110, the cutting flutes 116 protrude into the conduit 300 until the end stop 114 comes in contact with the terminal end wall 310 of the conduit 300. At this point, the drill may be powered down and the cutting flutes 116 may be extracted from the conduit opening 304.

The bit 110 may optionally be made in various sizes corresponding to the size of a conduit intended to be deburred. As indicated, the diameter of the end stop 114 of the drill bit 110 preferably corresponds to the diameter of the conduit to deburr, such that the end stop 114 is prevented from entering the conduit when the system is in use. This feature acts as both a convenience for the user, in stopping the progress of the cutting flutes 116 at a predetermined point, while also protecting the user from potentially harmful situations if the cutting flutes 116 were to reach too far into the conduit. The bit 110 may be installed and used quickly by one single user, making it an efficient means of conduit deburring. The bit 110 style is ideal for deburring conduit up to 1 inch in diameter, regardless of the schedule rating, and could be sized up for larger conduit. However, for conduit sized greater than nominal 1-inch diameter, the drill bit 110 and its various parts can become large, impractical, difficult to control, and/or dangerous.

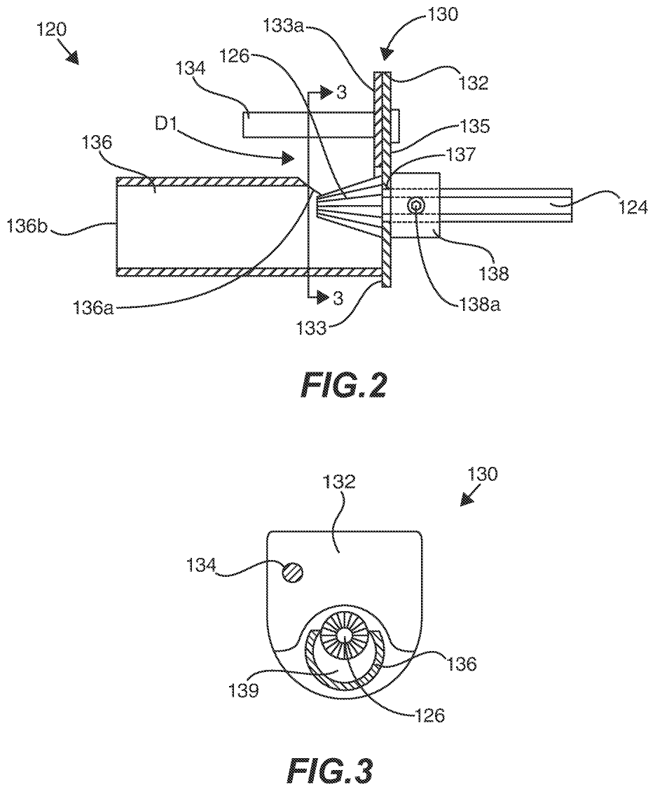

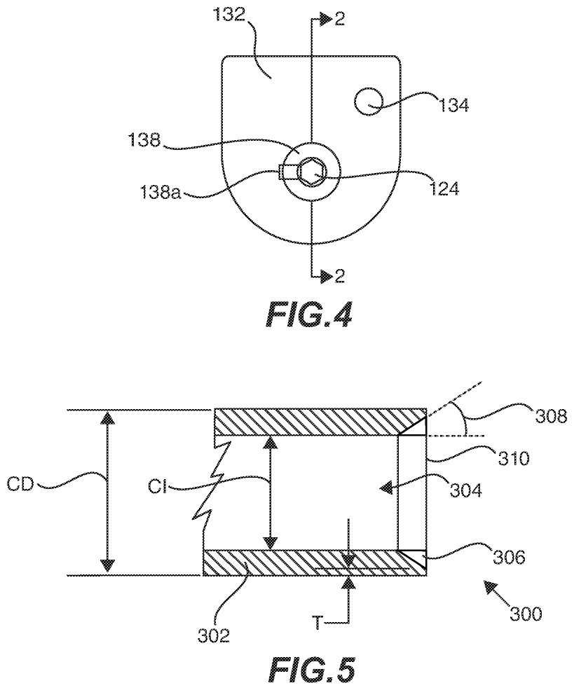

As shown in FIG. 2, in other embodiments of the present invention, the system for conduit deburr includes a deburr device 120 that may be better suited for deburring conduit of sizes equal to or greater than 1 inch in nominal diameter. This embodiment 120 generally includes a rotary file 122 and a registration device 130. The rotary file 122 preferably comprises a hex shank 124 and rotary head 126. The hex shank 124 is a device well known in the art, configured to pair with common types of drills for ease of the user. The rotary head 126 is preferably provides a frustoconical outer surface, with the wide end affixed to one end of the hex shank 124. While not exactly sharp, the rotary head 126 includes protrusions, formed during the manufacturing process, that create a rough surface. This enables the rotary head 126 to act similar to sandpaper to smooth an abrasive surface. Both the rotary head 126 and the hex shank 124 are preferably made of metal, such as various grades of carbon steel or cobalt, to withstand wear during use, maintenance, and storage. During manufacturing, the rotary head 126 and hex shank 124 may be formed together, i.e. made from the same piece of metal. Alternatively, the parts 124-126 may be made separately and attached at a later time to form the rotary file 122, e.g. welded together later in the manufacturing process. Alternatively, a fluted bit (e.g., bit 110) may be used.

According to an exemplary embodiment of the invention, the registration device 130 generally includes a guard 132, preferably having a conduit face 133 and a drill face 135, a locking collar 138 with a set screw 138a, a pipe guide 134, and a fitting pipe 136. The rotary file 122 preferably pairs with the registration device 130 to form the deburr device 120. The guard 132 includes an aperture 137 through which the hex shank 124 of the rotary file 122 is inserted during use. The aperture 137 (which is preferably slightly bigger in diameter than a maximum diameter of the shank 124 to allow rotation therein) extends through the guard 132, i.e. from the conduit face 133 through the drill face 135. When the rotary file 122 is installed through the aperture 137, the hex shank 124 extends away from the drill face 135 of the guard 132 while the rotary head 126 protrudes away from the conduit face 133, generally the guard 132 being longitudinally and rotatably movably disposed between the head 126 and the locking collar 138. The shank 124 is free to rotate within the aperture 137, thereby rotating the head 126. The guard 132 is preferably made of a tough, durable material, such as metal or hard plastic, to withstand wear during use, maintenance, and storage.

The conduit face 133 of the guard 132, as the name implies, faces a conduit end (e.g. a cut end) to be deburred, when the device 120 is in use. The conduit face 133 further includes a reinforcing layer 133a, preferably comprised of a second layer of the same material that the guard 132 is manufactured from. The reinforcing layer 133a covers a large portion of (e.g., a majority of or at least a majority between the pipe guide 134 and the fitting pipe 136) the conduit face 133. The reinforcing layer 133a helps maintain the structural integrity of the deburr device 120 when the device is in use. Specifically, the pipe guide 134 may experience heavy forces during device use and the reinforcing layer 133a (through which the pipe guide 134 extends) prevents the pipe guide 134 from becoming dislodged or displaced.

The pipe guide 134 is preferably a standoff or stud, which may be made of the same material as the guard 132. The pipe guide 134 extends (preferably generally parallel to and spaced a predetermined distance from the fitting pipe 136) through the guard 132 and the reinforcing layer 133a, i.e. the pipe guide 134 extends from the drill face 135 through the conduit face 133. The pipe guide 134 helps to register (i.e., maintain relative position of) the conduit to be deburred and the apparatus 120 during the deburring process. Also acting in this capacity is the fitting pipe 136. This pipe 136 is preferably a cylindrical tube with a cutaway 136a, the pipe 136 being affixed to and extending from the conduit face 133 of the guard 132 and a distal end 136b protruding away from the conduit face 133 of the guard 132. As can be seen, while the cutaway portion 136a is not affixed to the conduit face 133 of the guard 132, the rest of that end of the pipe 136 is connected to the conduit face 133 of the guard 132. This arrangement leaves a section of the rotary head 126 exposed. When the conduit is arranged over the fitting pipe 136 (between the pipe 136 and the pipe guide 134, generally in direction D1), this cutaway allows the rotary head 126 to rotate against the inside wall of a conduit edge.

When the rotary file 122 is installed into the deburr device 120 by inserting the hex shank 124 through the aperture 137, the hex shank 124 may be longitudinally restricted in place by a locking collar 138 (but still allowed to rotate within the aperture 137). This locking collar 138 is secured to the shank 124 and may frictionally engage the drill face 135 of the guard 132 surrounding the aperture 137. In use, the locking collar 138 prevents the rotary file 122 from substantial independent longitudinal movement from the rest of the deburr device 120 by way of a set screw 138a extending through the side of the locking collar 138 and being tightened against the hex shank 124. The set screw 138a may be loosened to insert or remove the rotary file 122 and tightened to lock the rotary file 122 thereto.

During use, the fitting pipe 136 is inserted into an opening of a conduit to be deburred, such that the conduit wall is situated between the fitting pipe 136 and the pipe guide 134. The hex shank 124 of the rotary file 122 is chucked in a drill or electric (or pneumatic) screwdriver while the rotary head 126 rests in contact with the conduit edge and/or inner wall. When the drill is powered on, the entire deburr device 120 rotates somewhat, causing the pipe guide 134 to come in contact with the outside wall of the conduit. The pipe guide 134 is then considered registered against the conduit and serves to keep the conduit wall in place as the deburring process moves on. As the deburr device 120 translates about the circumference of the conduit open end, the rough rotary head 126 acts to grind away any burrs left from a previous cutting process, leaving a smooth finish on the conduit edge and/or inner wall compared to the un-deburred conduit. When the desired finish is achieved, the drill is powered off and the conduit is removed from the deburr device 120 to be used in installing electrical wire.

A method according to the present invention may begin by determining a size of a conduit to be deburred. Usually, commercial conduit will be labelled with its size and schedule, making this a simple task, or it could be measured. Next, the type of conduit deburr system according to the present invention that would work best for the size of the conduit that needs to be deburred may be determined. This is a simple choice between the drill bit embodiment 100 or the deburr device embodiment 120, both described above.

For conduit sizes less than 1.25 inches, a drill bit 110 with an end stop 114 corresponding to the conduit size, as described above, is preferably chosen. The shank is chucked. The end 118 of the cutting flutes is then aligned with the conduit opening, and due at least in part to device symmetry, it has been discovered to generally align or center itself within the conduit. When alignment is attained to satisfaction, the drill is activated. The drill causes the drill bit, and thus the cutting flutes, to spin, which shaves off the burrs on the conduit edges and inner wall. Drilling is continued until the end stop 114 makes contact with the conduit edge. At that point, the drill is powered off, the cutting flutes are removed from the conduit opening, and the shank may be removed from the drill.

For conduit inside diameter sizes of a predetermined size (e.g., diameters greater than 1.25 inches), a deburr device 120 according to the present invention is preferably chosen. The rotary file may be installed into the aperture 137 in the deburr device (or may have been previously installed), with the hex shank extending from the drill face of the guard and the rotary head extending from the conduit face. If necessary, the set screw is then tightened on the locking collar. Once the rotary file is fastened, the hex shank is paired with a common drill. Since the hex shank is well known in the art, most known drills will be able to pair with the deburr device efficiently and safely.

The deburr device 120 is mated to a conduit to be deburred by fitting the conduit opening over the fitting pipe. The conduit wall is then aligned between the fitting pipe and the pipe guide, such that the rotary head makes contact with the conduit edge and/or inside wall. The drill is powered on and the deburr device rotates into place, registering the conduit between the pipe guide and fitting pipe. The deburr device then translates around the conduit wall, allowing the rotary head to shave off burrs from the conduit edge and inside wall until a smooth finish remains. When the conduit has been deburred to satisfaction, the drill is powered off, the conduit is removed from the fitting pipe, and the shank may be removed from the drill.

A method according to the present invention may further include the steps of providing a conduit or other tube to be deburred and/or cutting a conduit to a predetermined length prior to deburring.

The foregoing is considered as illustrative only of the principles of the invention. Furthermore, because numerous modifications and changes will readily occur to those skilled in the art, it is not desired to limit the invention to the exact construction and operation shown and described. While the preferred embodiment has been described, the details may be changed without departing from the invention.

What is claimed is:

1. A system for deburring conduit comprising:
a shank extending from a proximal free end to a distal end;
an end stop plate configured as a disk having a proximal side and an opposing distal side, wherein the proximal side of the end stop plate is coupled to the distal end of the shank; and
a plurality of cutting flutes extending from the distal side of the end stop plate,
wherein each cutting flute converges completely towards all other flutes, the flutes terminating at a pointed free end spaced from the distal side of the end stop plate.

2. The system according to claim 1, wherein the shank comprises a circular cross-section.

3. The system according to claim 1, wherein the shank comprises a hexagonal cross-section.

4. The system according to claim 1, wherein the end stop plate is formed integrally with the shank.

5. The system according to claim 4, wherein each cutting flute comprises two converging substantially right triangle side surfaces and an isosceles triangular radial surface.

6. The system according to claim 5, wherein the plurality of cutting flutes are bi-directionally operable.

7. A system for deburring conduit comprising:
a drill guard comprising a conduit face, drill face, and shank aperture;
a locking collar mechanically connected to the drill face of the drill guard, wherein the locking collar is co-axial with the shank aperture;
a pipe guide mechanically connected to the drill guard;
a fitting pipe affixed to and extending longitudinally from the conduit face of the drill guard; and
a rotary file comprising a shank, extending from a proximal free end to a distal end, and a rotary head affixed to the distal end of the shank,
wherein the rotary file is removably rotatably supported through the drill guard by threading the proximal free end of the hex shank through the shank aperture and locking the locking collar.

8. The system of claim 7, wherein the rotary head is frustoconical.

9. The system of claim 8, wherein the conduit face comprises a reinforcing layer.

10. The system of claim 9, wherein the pipe guide comprises a stud threaded through the drill guard, such that the pipe guide extends from the conduit face of the drill guard.

11. The system of claim 10, wherein the locking collar comprises a set screw.

12. A method of deburring conduit, the method comprising the steps of:
providing a conduit having an end to be deburred, the conduit having a cross-sectional diameter;
determining the size of the diameter;
based on the size, selecting a conduit deburr system;
contacting the conduit deburr system with the conduit; and
deburring the conduit.

13. The method of claim 12, wherein the determining step comprises ascertaining if the diameter is less than or greater than 1.25 inches in size.

14. The method of claim 13, wherein the diameter is determined to be less than 1.25 inches and the selected conduit deburr system comprises the deburr system according to claim 1.

15. The method of claim 14, wherein the installing step comprises the steps of chucking the shank to a drill and aligning the shank substantially coaxially with an opening in the end, the pointed ends of the cutting flutes extending into the conduit.

16. The method of claim 15, wherein the deburring step comprises the steps of:
activating the drill to rotate the shank;
drilling until the end stop plate makes contact with the conduit end;
deactivating the drill;
removing the cutting flutes from the conduit opening; and
removing the shank from the drill.

17. The method of claim 13, wherein the conduit is determined to be greater than 1.25 inches and the selected conduit deburr system comprises the deburr system of claim 7.

18. The method of claim 17, wherein the installing step further comprises the steps of:
chucking the hex shank to a drill; and
fitting the conduit over the fitting pipe until the rotary head contacts the conduit edge and/or inside wall.

19. The method of claim 18, wherein the deburring step further comprises the steps of:
activating the drill slowly to register the conduit between the pipe guide and fitting guide;
drilling until the rotary head shaves off the burrs of the conduit wall and leaves a smooth finish;
deactivating the drill;
removing the conduit from the fitting pipe; and
removing the shank from the drill.

20. The method of claim 19, wherein the providing step comprises the step of cutting the conduit to a predetermined length.
